(19) United States
(12) Patent Application Publication
(10) Pub. No.: US 2009/0023595 A1
(43) Pub. Date: Jan. 22, 2009

(54) METHOD FOR MEASURING A TARGET SUBSTANCE AND A KIT FOR MEASURING A TARGET SUBSTANCE

(75) Inventor: Koichi YAMAGATA, Kobe-shi (JP)

Correspondence Address: SUGHRUE MION, PLLC, 2100 PENNSYLVANIA AVENUE, N.W., SUITE 800, WASHINGTON, DC, 20037, US

(73) Assignee: SYSMEX CORPORATION, Kobe-shi (JP)

(21) Appl. No.: 12/054,117

(22) Filed: Mar. 24, 2008

(30) Foreign Application Priority Data
Mar. 23, 2007 (JP) 2007-76670

(51) Int. Cl. C40B 30/04; C40B 30/00; C40B 40/00

(52) U.S. Cl. 506/9; 506/7; 506/13

(57) ABSTRACT

The method for measuring the concentration of a target substance in a sample solution by fluorescence polarization method comprises steps of mixing the sample solution with a fluorescently labeled substance capable of binding to the target substance, dispensing the resulting mixture in micro-chambers of a micro-chamber array, measuring a value of fluorescence polarization or anisotropy with respect to each of the micro-chambers, and determining the concentration of the target substance in the sample solution on the basis of the measurement results.

### FIELD OF THE INVENTION

The present invention relates to a method for measuring the concentration of a target substance in a sample solution by a fluorescence polarization method and a kit therefor.

### BACKGROUND

In a high-throughput screening or in vitro diagnostic system where a large number of samples are measured in searching bioactive substances, detection systems excellent in simpleness, sensitivity and stability should be used in order to efficiently perform examinations. The existing detection systems are roughly divided into a system using a UV-visible absorbance method, a system using a chemiluminescence/bioluminescence method (fluorescence method) and a system using a radioisotope (RI).

The fluorescence method is a detection system where high selectivity and high sensitivity can be expected. Accordingly, the fluorescence method is often used along with the UV-visible absorbance method. The fluorescence method is also excellent in that the measurement time is shorter than in the method using RI, operation in a controlled area is not necessary, and there is no problem of radioactive wastes. Therefore, the fluorescence method comes to be a substitute for the method using RI.

However, when a large number of samples such as compound libraries and clinical samples containing blood components are examined, fluorescent samples are contained in some cases. In these samples, therefore, there is a problem that their measurement by the fluorescence method is sometimes disturbed by florescent contaminants.

The fluorescence polarization method is a method established by Perrin et al. in 1926. A target substance is detected by utilizing the phenomenon in which as a molecule becomes larger, the rotating speed of the molecule in rotational Brownian motion is decreased. A small molecule labeled with a fluorescent molecule shows a high rotating speed, and thus its fluorescence depolarization is fast. Accordingly, the fluorescence polarization value P indicates a small number. On the other hand, a large molecule labeled with a fluorescent molecule shows a low rotating speed, and thus its fluorescence depolarization is slow. Accordingly, P indicates a large number (Perrin, F. J. Phys. Rad. 1, 390-401, 1926). That is, when a fluorescently labeled substance capable of binding to a target substance binds to the target substance, P is increased. By measuring this change in P, the concentration of the target substance in a sample solution can be measured.

The fluorescence polarization value is calculated according to the following equation:

P=(IH−IL)/(IH+IL)

wherein IH is the intensity of emitted light polarized on the plane parallel to the plane of polarization of exciting light, and IL is the intensity of emitted light polarized on the plane perpendicular to the plane of polarization of exciting light.

As an indicator of the fluorescence polarization method, polarization anisotropy r is also used. A change in the value of polarization anisotropy r, similar to the fluorescence polarization value P, can be measured to determine the concentration of the target substance in a sample solution in this case as well. The relationship between the fluorescence polarization value P and the polarization anisotropy r can be expressed by the following equation:

r=2P/(3−P)

Specific examples of measurement of the concentration of a target substance in a sample solution by the fluorescence polarization method include fluorescence polarization immunoassay (FPIA). In this method, the concentration of a target substance is determined by using a calibration curve prepared from the relationship between antigen-antibody reaction and fluorescence polarization value. This method is used in measurement of the concentration of a substance having a relatively low molecular weight, particularly the concentration of a drug in blood. The fluorescence polarization immunoassay is a previously established technique (U.S. Pat. No. 4,420,568).

In the fluorescence polarization method, the concentration of a target substance in a sample solution can be measured without separating a bound fluorescently labeled substance to which a target substance is bound, from a free fluorescently labeled substance to which a target substance is not bound (B/F separation). That is, this method is a homogeneous assay system. However, when the amount of the target substance in a sample solution is very low, the influence of the free fluorescently labeled substance present in a large amount is so strong that the accurate detection of the bound fluorescently labeled substance is made difficult in some cases. In the fluorescence polarization method, therefore, the detection of a very small amount of a target substance is difficult. Accordingly, there is demand for development of the fluorescence polarization method for more accurately measuring a very small amount of a target substance.

Recently, high-speed analysis of very small amounts of samples becomes necessary in analysis of functions of a large number of genes and proteins in genomics and proteomics. For coping with such need, the development of DNA chips and proteo-chips is advancing for high-speed analysis of very small amounts of samples. Due to the advance of microfabrication technology, it became possible to manufacture microscopic chambers (micro-chambers). Further, it also became possible to utilize a CCD camera and computer processing in qualitative and semi-qualitative analysis.

A micro-chamber array is provided with a plurality of micro-chambers on a plate. Utilization of a micro-chamber array in screening a protein and microorganism having an enzyme activity and in detecting one-molecule enzyme activity etc. has been reported (US2007269794, JP2004309405).

### SUMMARY

The scope of the present invention is defined solely by the appended claims, and is not affected to any degree by the statements within this summary.

The object of the present invention is to provide a method for measuring the concentration of a target substance present in a very small amount in a sample solution by fluorescence polarization method, as well as a kit therefor.

### BRIEF DESCRIPTION OF THE DRAWINGS

FIG. 1 is a view showing one embodiment of the method for manufacturing a micro-chamber array by photolithography.

FIG. 2 is a view showing one embodiment of the method of using a micro-array chamber array 10.

FIG. 3 is a schematic view of one embodiment of the structure of container parts 13.

FIG. 4 is a graph showing the results of measurement of the concentrations of rabbit IgG in sample solutions by a fluorescence polarization method with a fluorescently labeled anti-rabbit IgG goat antibody using a micro-chamber array.

FIG. 5 is a graph showing the results of measurement of the concentrations of rabbit IgG in sample solutions by a conventional fluorescence polarization method with a fluorescently labeled anti-rabbit IgG goat antibody.

FIG. 6 is a graph showing the results of measurement of the concentrations of M13 mp18 ssDNA in sample solutions by a fluorescence polarization method with a fluorescently labeled probe using a micro-chamber array.

FIG. 7 is a graph showing the results of measurement of the concentrations of M13 mp18 ssDNA in sample solutions by a conventional fluorescence polarization method with a fluorescently labeled probe.

### DETAILED DESCRIPTION OF THE EMBODIMENT

The sample solution in the embodiment of the present invention is not particularly limited insofar as it can be dispensed in micro-chambers described later. For example, the sample solution is preferably a biological sample. The biological sample is particularly preferably a body fluid. Specific examples of the body fluid include blood, serum, plasma, urine, sweat, tissue fluid and a lysate of tissue.

The target substance in this embodiment is not particularly limited insofar as it is present in a sample solution and binds to a fluorescently labeled substance described later. Examples include a protein, a DNA, an RNA, a sugar, a cell etc. Particularly, a protein and a DNA are preferable.

The fluorescently labeled substance in this embodiment is not particularly limited as long as it has an ability to bind specifically to a target substance and can be detected by fluorescence polarization method. Examples include a fluorescently labeled antibody, a fluorescently labeled antigen, a fluorescently labeled protein, a fluorescently labeled peptide, a fluorescently DNA probe, and the like.

The fluorescently labeled substance is not particularly limited as long as it is a compound by which a target substance to which the fluorescently labeled substance was bound, and the free fluorescently labeled substance, can be detected by fluorescence polarization method. A fluorescent chromophore in the fluorescently labeled substance is preferably an organic fluorescent chromophore. The organic fluorescent chromophore include compounds having skeletons of rhodamine, pyrene, dialkylaminonaphthalene and cyanine. The organic fluorescent chromophore is preferably a compound having a pyrene skeleton, particularly preferably 6A-O-4-(1-pyrenyl) butanoyl-6X-O-4-(O-succinimidyl) succinoyl-β-cyclodextrin.

6A-O-4-(1-pyrenyl) butanoyl-6X-O-4-(O-succinimidyl) succinoyl-β-cyclodextrin is a known fluorescent chromophore and can be synthesized by using a known chemical synthesis method without particular limitation to the synthesis method.

The fluorescent chromophore used herein can be suitably selected in consideration of a change in molecular weight from a fluorescently labeled substance and a target substance. By selecting the fluorescent chromophore used, excitation wavelength, fluorescence wavelength, strokes shift, and fluorescence lifetime can be optimized. In this case, the strokes shift that is a difference in wavelength between excitation wavelength and fluorescence wavelength is preferably 5 nm or more, more preferably 20 nm or more. The fluorescence lifetime of the fluorescence chromophore (fluorescence relaxation time) is preferably in the range of 1 nanosecond to 1000 nanoseconds, more preferably in the range of 50 nanoseconds to 500 nanoseconds.

More specifically, when the change in molecular weight is about 5000 to 50000 (the molecular weight of the target substance to which a fluorescently labeled substance was bound is several thousands to several tens of thousands), a fluorescent chromophore having a fluorescence lifetime of 1 nanosecond to 15 nanoseconds is preferable. Examples of such fluorescent chromophores include cyanine and rhodamine. When the change in molecular weight is about 50000 to 500000 (the molecular weight of the target substance to which a fluorescently labeled substance was bound is several tens of thousands to several hundreds of thousands), a fluorescent chromophore having a fluorescence lifetime of 50 nanoseconds to 500 nanoseconds is preferable. Examples of such fluorescent chromophores include dialkylaminonaphthalene, a pyrene derivative etc. Particularly, 6A-O-4-(1-pyrenyl) butanoyl-6X-O-4-(O-succinimidyl) succinoyl-β-cyclodextrin is preferable. When the change in molecular weight is about 500000 to 5000000 (the molecular weight of the target substance to which a fluorescently labeled substance was bound is several hundreds of thousands to several millions), a fluorescent chromophore having a fluorescence lifetime of 100 nanoseconds to about 1000 nanoseconds is preferable. Examples of such fluorescent chromophores include a pyrene derivative, a metal complex etc.

The micro-chamber array in this embodiment is not particularly limited insofar as it has a plurality of micro-chambers wherein a target substance to which a fluorescently labeled substance was bound can be dispensed in each micro-chamber. An example of the micro-chamber array is a 1 cm² micro-chamber array having 10 to 10¹² micro-chambers, particularly 100 to 10⁸ micro-chambers.

A desired opening, depth and capacity of the micro-chamber may be established depending on the size of the target substance to which a fluorescently labeled substance was bound. When the target substance is for example a protein or a DNA, for example, the micro-chamber preferably has an opening diameter of 0.1 to 40 μm, a depth of 100 to 2000 nm and a capacity of 0.001 to 25000 fL. The micro-chamber is particularly preferably the one having a capacity of 1000 fL or less.

The method for manufacturing a micro-chamber array may be a known manufacturing method and is not particularly limited. For example, usual photomicrography can be used to prepare a micro-chamber array.

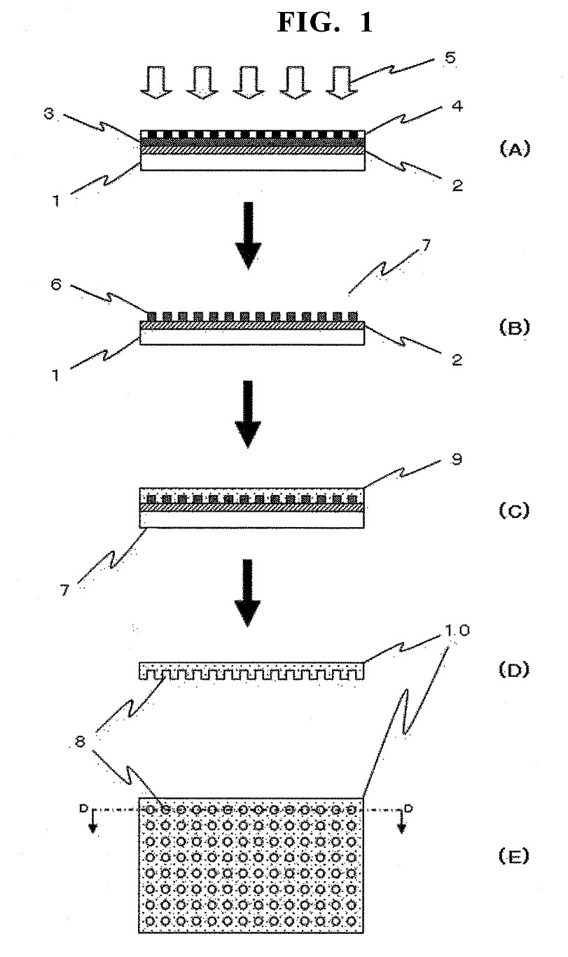

One embodiment of the method for manufacturing a micro-chamber array by photolithography is schematically shown in FIG. 1. A photoresist coat 3 formed by coating, with a photoresist, a gold film 2 vapor-deposited on a glass substrate 1, is provided with a patterned glass 4 having a chromium film with a predetermined pattern and then irradiated with an UV ray 5 (A).

Then, the photoresist on the photoresist coat 3 irradiated with the UV ray 5 is removed, and the photoresist film 6 remaining on the gold film 2, that is, the patterned photoresist on the gold film is used as a mold 7 (B). The part where the photoresist film 6 remains is a mold part corresponding to the micro-chamber 8. Accordingly, the size of the photoresist film 6 has substantially the same size as that of the micro-chamber 8 to be formed.

Then, liquid PDMS9 prepared by mixing polydimethylsiloxane (PDMS) with a curing agent in a predetermined ratio is applied onto the mold 7 and cured (C). In this step, the mold 7 on which liquid PDMS9 is supported is heated preferably at about 80° C. for about 60 minutes in order to accelerate curing of liquid PDMS9. In this manner, the curing of liquid PDMS9 is completed, and then the micro-chamber array 10 consisting of PDMS is released from the mold 7 (D). In this embodiment, the micro-chamber array 10 is PDMS which, while being mounted on the gold film 2, was cured, and can be easily released without performing any chemical treatment.

FIG. 1 (E) is a top view of the micro-chamber array 10 to show the openings of the micro-chambers 8. The micro-chambers 8 in this embodiment are cylindrical, but may be in any other forms. In this embodiment, the mold was produced using a positive photoresist wherein portions photosensitized with a UV ray are removed, but a negative photoresist wherein photosensitized portions remain may be used.

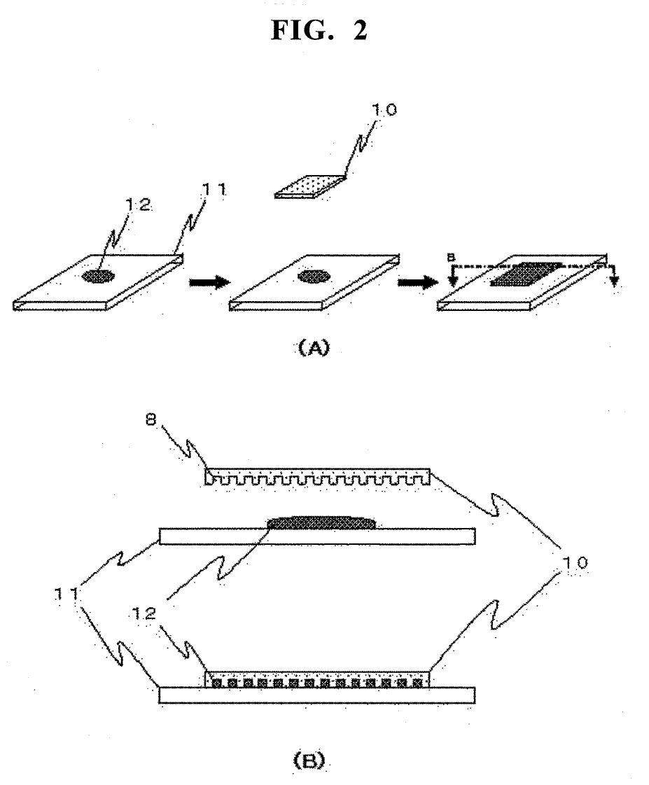

The micro-chamber array 10 prepared by the method described above is merely mounted on a slide glass 11 on which a liquid droplet of a sample solution 12 is held, whereby the sample solution 12 can easily dispensed in each of the micro-chambers 8 (FIG. 2). Accordingly, the user does not need skill in using the micro-chamber array 10 (see (A) in FIG. 2). By using the micro-chamber array, the volume of the sample solution 12 to be dispensed is defined by the micro-chamber 8. Accordingly, the liquid droplet is less varied than by spraying a liquid droplet into an organic solvent and suspending it (see B in FIG. 2).

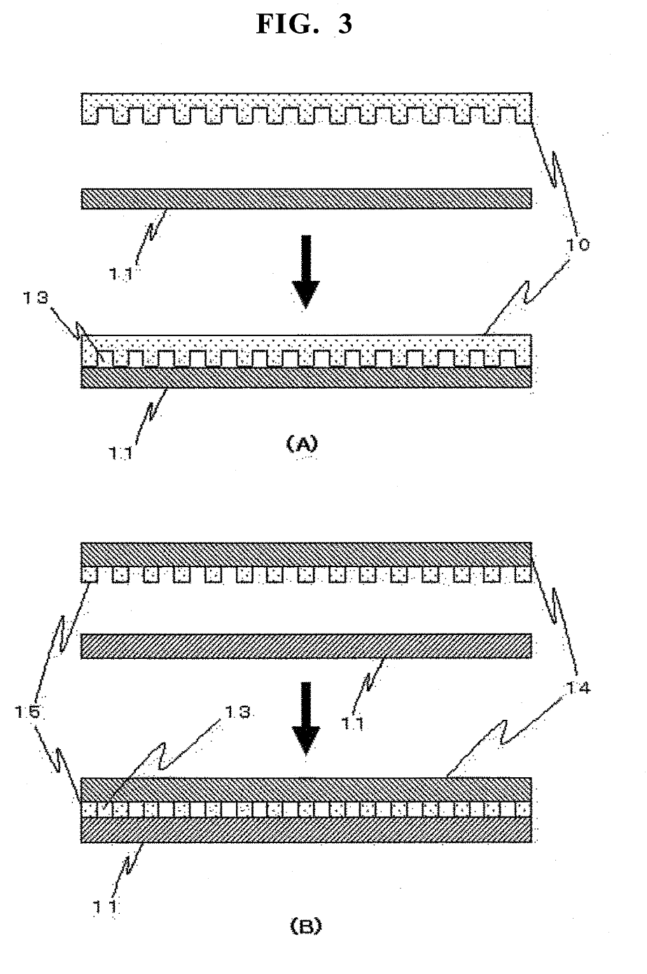

In this embodiment, the micro-chamber array 10 and the slide glass 11 is mounted to constitute container parts 13 (see (A) in FIG. 3). In another example, a micro-chamber array prepared by sticking a slide glass 14 to PDMS15 having through-holes may be mounted on a slide glass 11, thereby forming container parts 13 (see (B) in FIG. 3).

At least a part of the container part 13 is composed preferably of a polymer resin that is substantially water-impermeable. Particularly, the polymer resin is preferably an air-permeable polymer resin. By using such polymer resin, a liquid droplet encapsulated in the container part 13 is not leaked, and due to air permeability, air permeates and dissipates out of the container part. As a result, air can be prevented from remaining in the container part 13.

In this embodiment, the material of the micro-chamber array is not particularly limited insofar as it can form the micro-chamber array by using a mold formed by photolithography. Specifically, the micro-chamber array is composed of a polymer resin that is substantially water-impermeable. Particularly, the polymer resin is preferably an air-permeable polymer resin. Preferable examples include polydimethylsiloxane, silicon, polystyrene, acrylic resin, polymethyl methacrylate and polycarbonate, among which polydimethylsiloxane (PDMS) is preferable. Particularly, at least a part or a second member of the container part is formed preferably from PDMS. As a matter of course, the whole of the micro-chamber array may be formed from PDMS.

In this embodiment, the method of detecting, by fluorescence polarization method, micro-chambers in which a fluorescently labeled substance-bound target substance was dispensed is not particularly limited insofar as the fluorescence polarization value in the micro-chamber array can be measured to specify micro-chambers in which a fluorescently labeled substance-bound target substance was dispensed. For example, a fluorescence microscope having a polarized filter integrated therein, a system in which a CCD camera having a polarized filter integrated therein is combined with an excitation light source, and a spectrofluorometer having a polarized filter integrated therein are used.

More specifically, a sample containing a target substance and a fluorescently labeled substance are mixed in a solution, and the mixture is dispensed in a micro-chamber array, and the fluorescence polarization value of the fluorescently labeled substance in each micro-chamber is measured, thereby detecting micro-chambers in which the fluorescently labeled substance-bound target substance was dispensed. If necessary, the fluorescence polarization value of the fluorescently labeled substance in the absence of the target substance is also measured. This measurement is carried out preferably at moderate temperature (10 to 40° C.) at a constant temperature.

The fluorescence polarization value can be measured when a predetermined time has elapsed after the target substance is mixed with the fluorescently labeled substance. A change in the fluorescence polarization value per unit time can also be measured. By measuring the fluorescence polarization value when the binding of the fluorescently labeled substance to the target substance is completely finished, more reproducible measurements can be obtained.

Micro-chambers in which the fluorescently labeled substance-bound target substance was dispensed are detected, and the number of detected micro-chambers is compared with the number of micro-chambers possessed by the micro-chamber array, whereby the concentration of the target substance contained in the sample solution can be easily determined.

For example, when a micro-chamber array having 10⁸ 1-fL micro-chambers is used, 0.1 μL sample solution is dispensed in the micro-chamber array. When the number of micro-chambers in which the fluorescently labeled substance-bound target substance was dispensed is 6, 6molecules of the target substance were contained in 0.1 μL. Accordingly, the concentration of the target substance in the sample solution is 10⁻¹⁶ M.

In this embodiment, the kit for measuring a target substance is not particularly limited as long as it contains a micro-chamber array and a fluorescently labeled substance capable of binding to the target substance. By using this kit, the concentration of the target substance present in a very small amount in a sample solution can be measured by the above-described method for measuring a target substance.

### EXAMPLES

### Example 1

### <Preparation of Micro-Chamber Array>

After a gold thin film was vapor-deposited on a glass substrate, the gold thin film vapor-deposited on the glass substrate was coated with a photoresist. Then, a glass having formed a chromium film so as to have 10000 cylinders of 1 μm in diameter and 1 μm in height lengthwise and crosswise at 1-μm intervals (that is, 10⁸ cylinders in total) was mounted on the photoresist coat and irradiated with a UV ray. Then, the photoresist irradiated with a UV ray was removed, and the photoresist film remaining on the gold film, that is, the patterned photoresist on the gold film was used as a mold.

PDMS and a curing agent were mixed in a weight ratio of 10:1 to prepare liquid PDMS, and the liquid PDMS was applied onto the mold. PDMS applied onto the mold was cured at 80° C. for 60 minutes. After curing of PDMS was finished, PDMS was removed from the mold, to give a micro-chamber array.

### Example 2

<Synthesis of 6A-O-4-(1-pyrenyl) butanoyl-6X-O-4-(O-succinimidyl) succinoyl-β-cyclodextrin>

6A-O-4-(1-pyrenyl) butanoyl-6X-O-4-(O-succinimidyl) succinoyl-β-cyclodextrin 1 was synthesized according to the reaction scheme I below. In the reaction scheme I, the position of a substituent introduced into β-cyclodextrin is indefinite. When a positional mixture is theoretically generated, it was handled as a mixture of positional isomers.

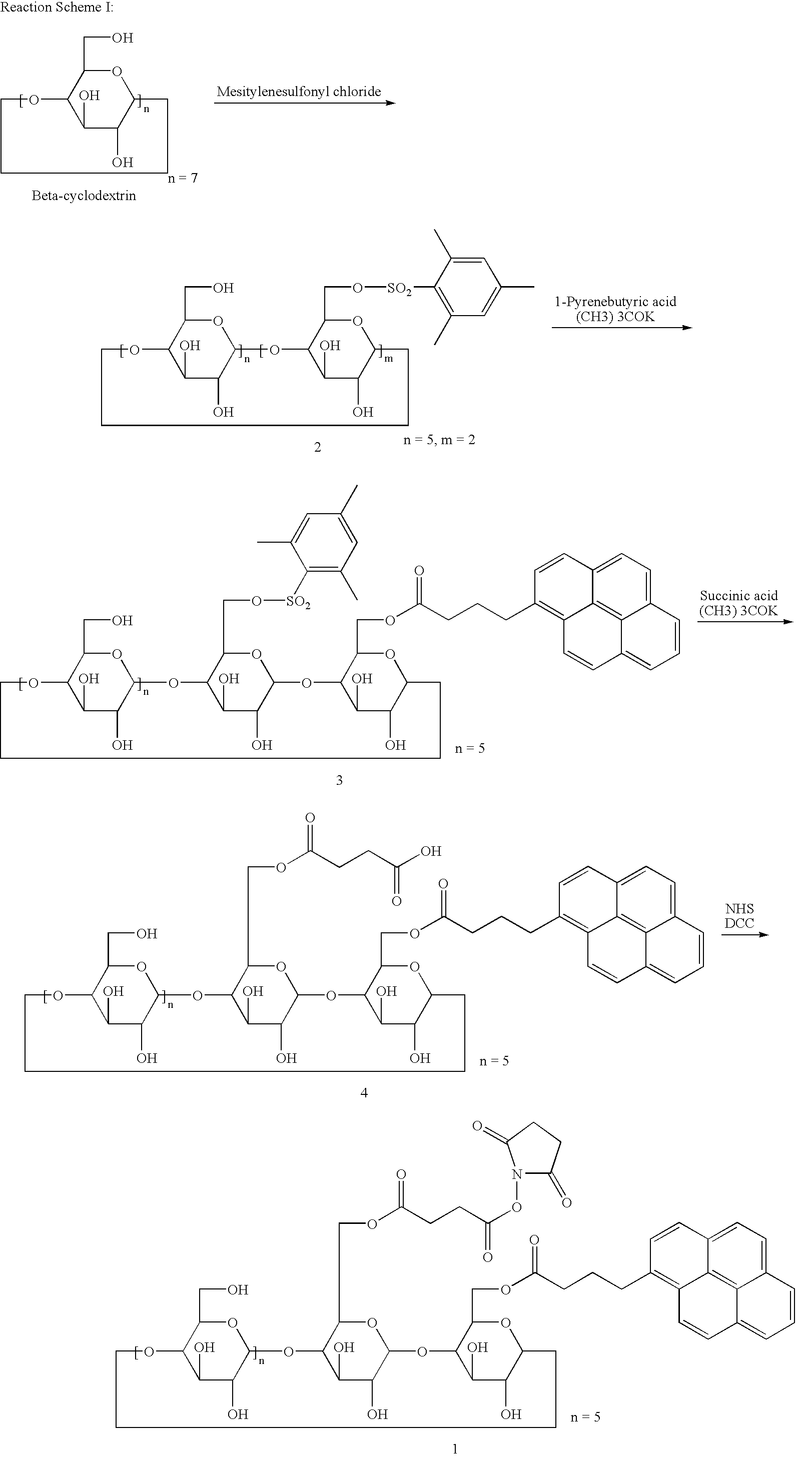

(1) Synthesis of 6A,6X-dimesityl-β-cyclodextrin 2

According to the reaction scheme I, 6A,6X-dimesityl-β-cyclodextrin 2 was synthesized from β-cyclodextrin. That is, β-cyclodextrin (5.675 g, 5 mmol) was dissolved in 100 mL pyridine under stirring, then mesitylenesulfonyl chloride (1.094 g, 5 mmol) was added to the mixture under stirring at room temperature, and the mixture was stirred for 2 hours. Additional mesitylenesulfonyl chloride (1.094 g, 5 mmol) was added thereto, stirred for 2 hours, and additional mesitylenesulfonyl chloride (1.094 g, 5 mmol) was added thereto and stirred for 3 hours. Thereafter, additional mesitylenesulfonyl chloride (1.094 g, 5 mmol) was added thereto and stirred for 2 hours. The reaction mixture was quenched by adding 20 mmol (360 μL) water, then the pyridine was distilled away so that the reaction mixture was concentrated to about 50 mL and then crystallized from acetone. Crude crystals were dissolved in hot water (100 mL), and the resulting solution while hot was applied onto a CHP-20P column (60 mL). The column was washed with 400 mL hot water(β-cyclodextrin was eluted), and eluted 6-O-mesityl-β-cyclodextrin (2.77 g, 2.1 mmol, 42%) using 30% hot methanol (400 mL) and 40% room-temperature methanol (200 mL), and thereafter, 6A,6X-O-dimesityl-β-cyclodextrin 2 (positional isomer mixture) was obtained.

Yield: 1.15 g (15%)

C₆₀H₉₀O₃₉S₂ (MW: 1499.5) LC-ESI/MS/MS: m/z 1521 (M+NA)

(2) Synthesis of 6A-O-4-(1-pyrenyl) butanoyl-6X-mesityl-β-cyclodextrin 3

According to the reaction scheme I, 6A-O-4-(1-pyrenyl) butanoyl-6X-mesityl-β-cyclodextrin 3 was then synthesized from 6A,6X-dimesityl-β-cyclodextrin 2. That is, 6A,6X-O-dimesityl-β-cyclodextrin 2 (1.25 g, 0.83 mmol) was dissolved in 15 mL dry dimethyl sulfoxide under stirring. While the mixture was stirred at room temperature, a solution of potassium t-butoxide (93.6 mg, 0.83 mmol) and 1-pyrenebutyric acid (240 mg, 0.83 mmol) in dimethyl sulfoxide (5 mL) was added thereto. Thereafter, the mixture was reacted under heating at 80° C. for 3 hours and then crystallized from added 1 L acetone. After washing with acetone, crude crystals were dissolved in 50 mL water and applied onto a CHP-20P column (20 mL), then washed with 1 L water, 1 L of 40% methanol and 1 L of 60% methanol and then eluted with 1 L of 80% methanol to give 6A-O-4-(1-pyrenyl) butanoyl-6X-O-mesityl-β-cyclodextrin 3 (positional isomer mixture).

Yield: 410 mg (31%)

C₇₁H₄₉O₃₈S (MW; 1587.5) LC-ESI/MS/MS:m/z 1609 (M+NA)

(3) Synthesis of 6A-O-4-(1-pyrenyl) butanoyl-6X-O-4-succinoyl-β-cyclodextrin 4

According to the reaction scheme I, 6A-O-4-(1-pyrenyl) butanoyl-6X-O-4-succinoyl-β-cyclodextrin 4 was synthesized from 6A-O-4-(1-pyrenyl) butanoyl-6X-mesityl-β-cyclodextrin 3. That is, the previously obtained 6A-O-4-(1-pyrenyl) butanoyl-6X-mesityl-β-cyclodextrin 3 (80 mg, 0.05 mmol) was dissolved in 1 mL dry dimethyl sulfoxide under stirring, and succinic acid (118 mg, 1 mmol) was successively added thereto and dissolved therein. While the mixture was stirred at room temperature, a solution of potassium t-butoxide (112 mg, 1 mmol) in dimethyl sulfoxide (1 mL) was slowly added thereto. Thereafter, the mixture was stirred at 80° C. for 48 hours. After the reaction, the reaction solution was filtered and then crystallized by adding 50 mL acetone to the reaction solution. After washing with acetone, crude crystals were dissolved in 20 mL water and applied onto a CHP-20P column (20 mL). After the column was washed with 500 mL water and 500 mL of 40% methanol, the sample was eluted with 500 mL of 60% methanol and 500 mL of 80% methanol, but the starting material 3 and the reaction product were eluted without being separated from each other, so their eluent was concentrated, and the reaction product 6A-O-4-(1-pyrenyl) butanoyl-6X-O-4-succinoyl-β-cyclodextrin 4 was converted with sodium carbonate into the corresponding sodium salt and then subjected to separation and purification by HPLC. HPLC conditions are as follows:

Column: Cosmosyl 5C18-AR-300 4.6 mm×150 mm
Flow rate: 1 mL/min
Detection wavelength: 250-500 nm
Eluent: 30-100% methanol

### Gradient:

TABLE 1

| | Time (mm) | | | | | | |
|---|---|---|---|---|---|---|---|
| | 0 | 2 | 5 | 20 | 22 | 24 | 28 |
| Water (%) | 70 | 70 | 35 | 23 | 0 | 70 | 70 |
| Methanol (%) | 30 | 30 | 65 | 77 | 100 | 30 | 30 |

Under the conditions described above, peaks at 11 to 13 minutes were collected and distilled away to give a sodium salt of 6A-O-4-(1-pyrenyl) butanoyl-6X-O-4-succinoyl-β-cyclodextrin 4 (16 mg). By adding 1N hydrochloric acid, 4 was converted into the corresponding carboxylic acid to give a turbid solution which was then once distilled away. The resulting crystals were dissolved again in methanol and developed by silica gel thin layer chromatography (isopropyl alcohol:ethyl acetate:water=7:7:5), and from a band with Rf=0.6, 6A-O-4-(1-pyrenyl) butanoyl-6X-O-4-succinoyl-β-cyclodextrin 4 (positional isomer mixture) was obtained.

Yield: 15 mg (20%)

C₆₆H₈₈O₃₉ (MW; 1505.4) LC-ESI/MS/MS:m/z 1549 (M−H+2NA)

(4) Synthesis of 6A-O-4-(1-pyrenyl) butanoyl-6X-O-4-(O-succinimidyl) succinoyl-β-cyclodextrin 1

According to the reaction scheme I, 6A-O-4-(1-pyrenyl) butanoyl-6X-O-4-(O-succinimidyl) succinoyl-β-cyclodextrin 1 was synthesized from 6A-O-4-(1-pyrenyl) butanoyl-6X-O-4-succinoyl-β-cyclodextrin 4. That is, 6A-O-4-(1-pyrenyl) butanoyl-6X-O-4-succinoyl-β-cyclodextrin 4 (2.25 mg, 1.5 μmol) was weighed out in a reaction vessel, and a solution of N-hydroxysuccinimide (NHS, 17.3 mg, 150 μmol) in dimethyl formamide (0.5 mL) was added thereto under stirring. A solution of dicyclohexyl carbodiimide (DCC, 31.0 mg, 150 μmol) in dimethyl formamide (0.5 mL) was added thereto under stirring. The mixture was stirred at room temperature, and from 1.5 hours after the reaction was initiated, product peaks were fractionated and purified by HPLC. Three peaks of insufficiently separated products derived from the mixture of positional isomers were recognized, and it was confirmed by mass spectroscopy that any of these products were confirmed to be 6A-O-4-(1-pyrenyl) butanoyl-6X-O-4-(O-succinimidyl) succinoyl-β-cyclodextrin 1 (positional isomers), and thus these 3 fractions (from 15 min. to 17 min.) were collected and combined (HPLC conditions were the same as in purification of 6A-O-4-(1-pyrenyl) butanoyl-6X-O-4-succinoyl-β-cyclodextrin 4). After the mobile phase was distilled away, 6.5 mg white crystals were obtained. It was confirmed by mass spectroscopy that dicyclohexyl urea (DCU), that is, a decomposition product of DCC, was contained in addition to 6A-O-4-(1-pyrenyl) butanoyl-6X-O-4-(O-succinimidyl) succinoyl-β-cyclodextrin 1, but the white crystals were used directly in protein labeling because DCU did not have absorption in the UV range, the amount of 6A-O-4-(1-pyrenyl) butanoyl-6X-O-4-(O-succinimidyl) succinoyl-β-cyclodextrin 1 was small, separation of DCU from 6A-O-4-(1-pyrenyl) butanoyl-6X-O-4-(O-succinimidyl) succinoyl-β-cyclodextrin 1 was difficult, and it was expected that DCU would not interfere with the later reaction of 6A-O-4-(1-pyrenyl) butanoyl-6X-O-4-(O-succinimidyl) succinoyl-β-cyclodextrin 1 with a protein.

C₇₀H₉1O₄₁N (MW: 1602.45) LC-ESI/MS/MS: m/z 1624 (M+NA)

### Example 3

### <Measurement of the Concentration of Rabbit IgG in a Sample Solution by Using a Fluorescently Labeled Anti-Rabbit IgG Goat Antibody>

### 1) Preparation of a Fluorescently Labeled Anti-Rabbit IgG Goat Antibody

An anti-rabbit IgG goat antibody was fluorescently labeled with 6A-O-4-(1-pyrenyl) butanoyl-6X-O-4-(O-succinimidyl) succinoyl-β-cyclodextrin. That is, an anti-rabbit IgG goat antibody (0.8 mg, 5.3 nmol) was buffer-exchanged by Centricon 100 to prepare 500 μL of its solution in 50 mM sodium carbonate, pH 9.76. The crude crystals (1.3 mg, theoretical maximum content: 1 μmol) of 6A-O-4-(1-pyrenyl) butanoyl-6X-O-4-(O-succinimidyl) succinoyl-β-cyclodextrin obtained in Example 2 were dissolved in 12.5 μL dimethylformamide, then added to the rabbit IgG goat antibody solution and stirred at 4° C. for 15 hours.

After the reaction, 200 μL of 50 mM Tris-HCl buffer, pH 8.0 was added to the reaction solution. The reaction solution was applied onto a HiTrap Desalting column (5 mL) previously buffer-exchanged by 50 mM Tris-HCl buffer, pH 8.0. The sample was eluted with 50 mM Tris-HCl buffer, pH 8.0. The eluent was fractionated (5 drops/fraction), and fractions recognized to have absorptions of the protein and pyrene in UV spectra were combined (600 μL). When this solution was measured for its protein concentration with a protein quantification kit manufactured by Bio-Rad, the concentration was 1.1 mg/mL (the molar concentration of anti-rabbit IgG goat antibody: 7.3 μM). The concentration of pyrene, as determined from absorbance at 345 nm and the molar extinction coefficient (5×10⁴) of pyrene, was 20 μM. From this result, it was confirmed that average 2.7 molecules of 6A-O-4-(1-pyrenyl) butanoyl-6X-O-4-(O-succinimidyl) succinoyl-β-cyclodextrin had been bound to one molecule of the anti-rabbit IgG goat antibody.

2) Mixing of Rabbit IgG in a Sample Solution with the Fluorescently Labeled Anti-Rabbit IgG Goat Antibody

Sample solutions of rabbit IgG were prepared at concentrations of 10 nM, 1 nM, 100 pM, 10 pM, 1 pM, 100 fM, 10 fM and 1 fM in 20 mM PBS, pH 7.3. 5 μL of each sample solution was mixed with 5 μL solution obtained by diluting the fluorescently labeled anti-rabbit IgG goat antibody prepared in 1) at a final concentration of 2 nM with 20 mM PBS, pH 7.3, to prepare a reaction solution. Both the sample solution and the fluorescently labeled anti-rabbit IgG goat antibody solution had been set at 37° C., and the point of time when they were mixed was regarded as 0 minute after the reaction was initiated.

### 3) Detection of Micro-Chambers of the Rabbit IgG Bound to the Fluorescently Labeled Anti-Rabbit IgG Goat Antibody by Fluorescence Polarization Method

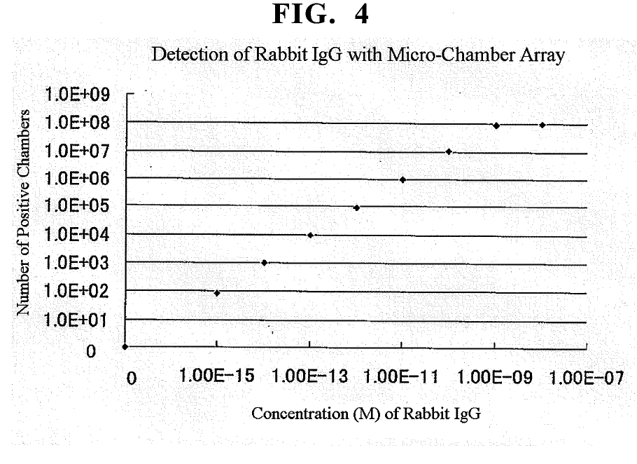

5 μL of the mixture was immediately dropped onto a slide glass, and the micro-chamber array prepared in Example 1 was placed on the mixture on the slide glass, whereby the mixture was dispensed in each of micro-chambers of the micro-chamber array. The mixture remaining on the slide glass was removed with a filter paper, and micro-chambers in which the rabbit IgG bound to the fluorescently labeled anti-rabbit IgG goat-antibody was present were detected by measuring the fluorescence polarization value at 5 minutes, 8 minutes and 10 minutes with a fluorescence microscope system having both a polarized filter excitation light side and a fluorescence side integrated therein (Olympus Corporation). The results of measurement of rabbit IgG in the sample solution, derived from the detection results, are shown in FIG. 4. The measurement temperature was set at 37° C.

### Comparative Example 1

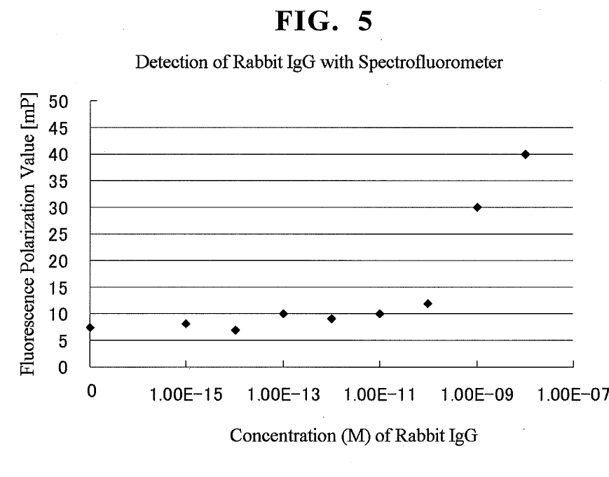

Using a fluorescently labeled anti-rabbit IgG antibody and sample solutions prepared in the same manner as in Example 3, the fluorescence polarization value was measured with a fluorescence spectrophotometer FLS920 (Hamamatsu Photonics K.K.) with an option for fluorescence polarization measurement. That is, 50 μL fluorescently labeled anti-rabbit IgG antibody solution diluted at a final concentration of 2 nM with 20 mM PBS, pH 7.3 was added to a fluorescence cell, and 50 μL sample solution prepared at each concentration was added to the fluorescence cell to initiate measurement, and the fluorescence polarization value at 5 minutes, 8 minutes and 10 minutes was measured. The measurement temperature was set at 37° C. The measurement results are shown in FIG. 5.

As is evident from FIGS. 4 and 5, the concentration of a sample solution, even at a concentration as low as 10 fM or less, can be determined by the fluorescence polarization method using the micro-chamber array, while the concentration of a sample solution at a concentration of 10 pM or less cannot accurately be determined by the usual fluorescence polarization method.

### Example 4

<Measurement of the Concentration of M13 mp18 ssDNA in a Sample Solution by Using a Fluorescently Labeled DNA Probe>

### 1) Preparation of a Fluorescently Labeled Probe

A 15-base DNA probe complementary to M13 mp18 ssDNA and having an amino group at the 5′-terminal thereof (referred to hereinafter as M13 probe) was fluorescently labeled with 6A-O-4-(1-pyrenyl) butanoyl-6X-O-4-(O-succinimidyl) succinoyl-β-cyclodextrin. That is, 500 μL solution of M13 probe (10 nmol) in 50 mM sodium carbonate buffer, pH 9.76 was prepared. The crude crystals (1.3 mg, theoretically maximum content: 1 μmol) of 6A-O-4-(1-pyrenyl) butanoyl-6X-O-4-(O-succinimidyl) succinoyl-β-cyclodextrin obtained in Example 2 were dissolved in 12.5 μL of dimethylformamide, then added to the solution of M13 probe and stirred at 4° C. for 15 hours.

After the reaction, the reaction mixture was separated and purified by HPLC having a photodiode array as a detector. In this case, the objective fluorescently labeled M13 probe was fractionated as a peak having absorptions of DNA and pyrene. Separation and purification by HPLC was carried out. HPLC conditions are as follows:

Column: Cosmosyl 5C18-AR-300 4.6 mm×150 mm
Flow rate: 1 mL/min
Detection wavelength: 250-500 nm
Eluent: 30-100% methanol

### Gradient:

TABLE 2

| | Time (mm) | | | | | |
|---|---|---|---|---|---|---|
| | 0 | 10 | 30 | 45 | 50 | 60 |
| 10 mM TEAA (%) | 5 | 95 | 40 | 5 | 5 | 95 |
| Acetonitrile (%) | 5 | 5 | 60 | 95 | 95 | 5 |

*TEAA: triethylamine-acetate buffer

When 500 μL of the fractionated solution was measured for its DNA concentration from absorbance at 260 nm, the DNA concentration was 5.0 μM. The concentration of pyrene, as determined from absorbance at 345 nm and the molar extinction coefficient (5×10⁴) of pyrene, was 4.6 μM. From this result, it was confirmed that average 0.92 molecule of 6A-O-4-(1-pyrenyl) butanoyl-6X-O-4-(O-succinimidyl) succinoyl-β-cyclodextrin had been bound to one molecule of M13 probe.

2) Mixing of M13 ssDNA in a Sample Solution with the Fluorescently Labeled Probe

Sample solutions of M13 mp18 ssDNA were prepared at concentrations of 10 nM, 1 nM, 100 pM, 10 pM, 1 pM, 100 fM, 10 fM and 1 fM in 10 mM Tris-HCl, pH 8.0 containing 0.1 N NaCl.

5 μL of each sample solution was mixed with 5 μL solution obtained by diluting the fluorescently labeled M13 probe prepared in 1) at a final concentration of 2 nM with 10 mM Tris-HCl, pH 8.0 containing 0.1 NaCl, to prepare a reaction solution. Both the sample solution and the fluorescently labeled (M13) probe had been set at 37° C., and the point of time when they were mixed was regarded as 0 minute after the reaction was initiated.

3) Detection of Micro-Chambers of the Fluorescently Labeled Probe-Bound M13 ssDNA by Fluorescence Polarization Method

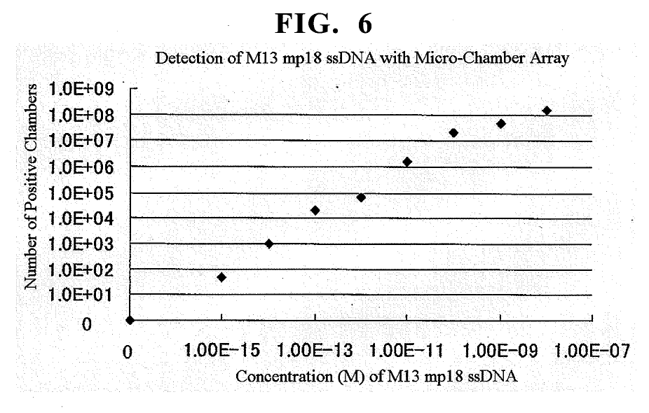

5 μL of the mixture was immediately dropped onto a slide glass, and the micro-chamber array prepared in Example 1 was placed on the mixture on the slide glass, whereby the mixture was dispensed in each of micro-chambers of the micro-chamber array. The mixture remaining on the slide glass was removed with a filter paper, and micro-chambers in which the fluorescently labeled M13 probe-bound M13 mp18 ssDNA was present were detected by measuring the fluorescence polarization value at 5 minutes, 8 minutes and 10 minutes with a fluorescence microscope system having both a polarized filter excitation light side and a fluorescence side integrated therein (Olympus Corporation). The results of measurement of M13 mp18 ssDNA in the sample solution, derived from the detection results, are shown in FIG. 6. The measurement temperature was set at 37° C.

### Comparative Example 2

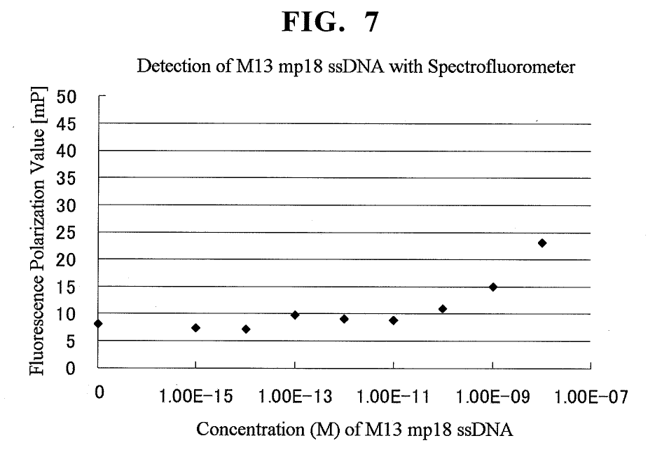

Using a fluorescently labeled M13 probe and sample solutions prepared in the same manner as in Example 4, the fluorescence polarization value was measured with a fluorescence spectrophotometer FLS920 (Hamamatsu Photonics K.K.) with an option for fluorescence polarization measurement. That is, 50 μL fluorescently labeled M13 probe solution diluted at a final concentration of 2 nM with 10 mM Tris-HCl, pH 8.0 containing 0.1 N NaCl was added to a fluorescence cell, and 50 μL of the sample solution prepared at each concentration was added to the fluorescence cell to initiate measurement, and the fluorescence polarization value at 5 minutes, 8 minutes and 10 minutes was measured. The measurement temperature was set at 37° C. The measurement results are shown in FIG. 7.

As is evident from FIGS. 6 and 7, the concentration of a sample solution, even at a concentration as low as 10 fM or less, can be determined by the fluorescence polarization method using the micro-chamber array, while the concentration of a sample solution at a concentration of 10 pM or less cannot accurately be determined by the usual fluorescence polarization method.

From the above results, it was revealed that the method for measuring a target substance according to the present invention, as compared with the method of measuring the concentration of a target substance in a sample solution by the conventional fluorescence polarization method, can determine the concentration of a target substance at a very low concentration.

The foregoing detailed description and examples have been provided by way of explanation and illustration, and are not intended to limit the scope of the appended claims. Many variations in the presently preferred embodiments will be obvious to one of ordinary skill in the art, and remain within the scope of the appended claims and their equivalents.

What is claimed is:

1. A method for measuring a target substance in a sample solution, comprising steps of:
mixing the sample solution with a fluorescently labeled substance capable of binding to the target substance;
dispensing the resulting mixture in micro-chambers of a micro-chamber array;
measuring a value of fluorescence polarization or anisotropy with respect to each of the micro-chambers; and
determining the concentration of the target substance in the sample solution on the basis of the measurement results.

2. The method according to claim 1, wherein the sample solution is a biological sample.

3. The method according to claim 2, wherein the biological sample is a body fluid.

4. The method according to claim 3, wherein the body fluid is blood, serum, plasma, urine, sweat or tissue fluid.

5. The method according to claim 1, wherein the target substance is a protein or a DNA.

6. The method according to claim 1, wherein the fluorescently labeled substance is a fluorescently labeled antibody, a fluorescently labeled antigen or a fluorescently labeled probe.

7. The method according to claim 1, wherein a fluorescent chromophore of the fluorescently labeled substance is an organic fluorescent chromophore.

8. The method according to claim 7, wherein the organic fluorescent chromophore has a skeleton of rhodamine, pyrene, dialkylaminonaphthalene or cyanine.

9. The method according to claim 7, wherein the fluorescent chromophore is 6A-O-4-(1-pyrenyl) butanoyl-6X-O-4-(O-succinimidyl) succinoyl-β-cyclodextrin.

10. The method according to claim 1, wherein the diameter of an opening of the micro-chamber is 0.1 to 40 μm.

11. The method according to claim 1, wherein the depth of the micro-chamber is 100 to 2000 nm.

12. The method according to claim 1, wherein the capacity of the micro-chamber is 0.001 to 25000 fL.

13. The method according to claim 1, wherein the number of micro-chambers possessed by the micro-chamber array is 10 to 10¹² per cm².

14. The method according to claim 1, wherein the determining step is performed by obtaining a number of the micro-chambers containing the fluorescently labeled substance-bound target substance on the basis of the measuring result, and determining the concentration of a target substance in the sample solution on the basis of the obtained number.

15. The method according to claim 14, wherein determining step is performed by determining the concentration of a target substance on the basis of the obtained number and the amount of the mixture dispensed in the micro-chambers.

16. The method according to claim 14, wherein the number is obtained on the basis of difference between the value of a micro-chamber containing the labeled substance-bound target substance and a micro-chamber not containing the labeled substance-bound target substance

17. A kit for measuring a target substance comprising a micro-chamber array and a fluorescently labeled substance capable of binding to the target substance.
